(19) United States
(12) Patent Application Publication
(10) Pub. No.: US 2019/0180641 A1
(43) Pub. Date: Jun. 13, 2019

(54) System and Method for Draft-Contemporaneous Essay Evaluating and Interactive Editing

(71) Applicants: Robin Donaldson, Durham, NC (US); Jamey Heit, Durham, NC (US)

(72) Inventors: Robin Donaldson, Durham, NC (US); Jamey Heit, Durham, NC (US)

(21) Appl. No.: 15/835,307

(22) Filed: Dec. 7, 2017

(51) Int. Cl. G09B 7/04; G09B 19/00

(52) U.S. Cl. CPC G09B 7/04; G09B 19/00

(57) ABSTRACT

The present invention is a computer-based method and system to provide a student of language arts or a language-arts program component automated feedback on an essay. Assignment Input including Essay Prompt, Key Themes, and a Sample Essay are loaded onto a computer device. Contemporaneously with a student's essay writing effort, a Function derives Specific Metric Values for each of the Assignment Input and Student Input, compares the values, and provides real-time feedback to the student based upon the Values' relative positions along a spectrum. The Metric Values may also be output to a node monitored by an instructor.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Primary school and secondary school budget cuts are as commonplace as the requirement for schoolchildren to perform and improve upon writing samples. At the same time, demand for safe schools and quality educational experiences for students with hugely varying backgrounds continues to grow unabated. As a consequence, many public and private schools must explore ways to arrive at good educational outcomes while simultaneously trimming costs. In effect, such schools must adopt the mantra to, “Do More with Less,” yet must maintain evenly-applied high standards while providing instruction to students and while grading student work.

Simultaneously, research suggests that grades applied to essays by human graders show wide deviation based upon individual human bias, education, and may be readily swayed by fancy writing devoid of content, or may skim the passage, or simply review the spelling and grammar of an essay. As a result, human grading, and algorithms based upon human grading, are poor methods of objectively determining the presence of essay organization, use of evidence, analysis, clarity and concision in measuring the quality of an essay and assigning a grade.

In a non-limiting example of the limitations of current grading systems, an automated grading system employing machine learning generates a grading algorithm by analyzing example essays for a specific essay prompt with preassigned human grades. Machine learning finds elements within the essays that appear more commonly in essays with good human grades versus essays with poor human grades. New essays are evaluated by the now calibrated machine learning tool are graded using an algorithm built through the collaboration of the machine learning tool, the programmer who created the machine learning training protocol, and one or more teachers who graded the example essays. However, these algorithms represent a “black box” in that the process by which the algorithm “scores” different sets of documents is opaque to the writer. Additionally, feedback for the writer cannot be generated using these algorithms, and the grades assigned are, as a result, unjustified. An additional commonly used approach to grading essays is a pattern-based approach, where the grader is simply looking for the types of patterns in wording and context that the grader feels are important. A grader then assigns a grade based upon whether the patterns they wish to see are included in the essay or not, producing a grade that is also unjustified for a different reason. A writer who wishes to improve the score he or she receives on an essay would have no way of knowing which aspect or aspects of his or her writing needed work.

A separate but no less important challenge for instructors is ensuring that a student's claim of essay authorship is bona fide. For example, although plagiarism is a well-known time-worn concern of instructors, the advent of the Internet has made the providing of plagiarized texts, and methods to evade detection of the same, into a cottage industry. Not only are pre-written essays available for purchase from the unscrupulous, there exist software programs that make plagiarized text look adequately different from known works to successfully pass computer review for plagiarism and possibly, human review as well.

Many existing approaches to preventing a plagiarist from passing off another's work as his own rely on ready access to a complete database of writing. Given the incredibly large number of documents written for review annually, any such database is necessarily incomplete, and any system based upon such a database is fallible. Still other software programs produce a percentage score to indicate the amount of material in the essay that is found in other documents. Such a non-binary score leaves the instructor or monitor having to make an arbitrary judgment call as to at what score a paper warrants attention for possible plagiarism and at what score such a paper is considered to be above suspicion for the same.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a process flow diagram for an exemplary system operation consistent with certain embodiments of the present invention.

FIG. 2 is a spectrum of metric values diagram consistent with certain embodiments of the present invention.

FIG. 3 is a system diagram consistent with certain embodiments of the present invention.

FIG. 4 is a diagram of the determination of constituent parts of an essay consistent with certain aspects of the present invention.

FIG. 5 is a process flow diagram of the determination of an author Fingerprint consistent with certain aspects of the present invention.

FIG. 6 is a detail diagram of the constituent determinations involved in calculating an author Fingerprint consistent with certain aspects of the present invention.

FIG. 7 is a process flow diagram of the determination of Classification Values for a new document of undermined authorship consistent with certain aspects of the present invention.

FIG. 8 is a process flow diagram of the application of Classification Values to determination of an essay classification consistent with certain aspects of the present invention.

FIG. 9 is a process flow diagram of analysis of a set of documents of unknown authorship in the absence of a baseline of documents with verified authorship, consistent with certain aspects of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to the words, “essay,” or “essays,” is intended to include all essay types, including but not limited to: Argumentative, Cause and Effect, Classification, Compare and Contrast, Definition, Example, Personal Narrative, Problem/Solution, Process, Research Paper, Research Proposal, Response to Article, Short Answer, Statement of Purpose, Summary Response, and Synthesis.

References herein to “Mechanistic Assessment” refer to a process for determining the presence of metric-satisfying contextual, grammatical, and linguistic elements during the essay-writing process. Such Mechanistic Assessment employs computer modeling of high-quality writing using various pre-defined metrics.

References herein to a “stopword”, refers to a common English word such as “a,” “and,” “is,” “on,” of,” “or,” or “the.”

As previously described, human approaches to grading student written works tend to produce widely varied and inaccurate results. Such deviation can be explained in part by wide variances in human grader education, individual bias, and susceptibility to being swayed by high level correlates. Because machine learning algorithms are often based upon human grading methods and datasets, these grading methods often share the same limitations as human grading methods themselves.

Separately, while students can rely on spell checker software to correct the misspelling of a number of words in common usage, absent the presence of a human tutor, these same students cannot be guaranteed real-time, contemporaneous feedback upon one or more drafts of essays during the writing process. Thus, a need exists to address the limitations of human grading and the machine learning algorithms based upon human grading while simultaneously providing writers real-time feedback during the writing process.

The present innovation employs a novel method, defined as a “Mechanistic Assessment”, to determine the presence of metric-satisfying contextual, grammatical, and linguistic elements during the essay-writing process. Such Mechanistic Assessment employs computer modeling of high-quality writing using various pre-defined metrics. An algorithm using Mechanistic Assessment may then alert a writer immediately upon determination that the writer is performing poorly in relationship to one or more of such metrics. A rubric describing the computed metrics for an essay may be provided to the writer.

Mechanistic Assessment may be used to grade an essay at each point in the writing process, from drafting the first words of an introduction to performing redrafts of a completed draft essay. Such assessment uses caching techniques to store all possible parsing and relationship computation data, resulting in grading an altered version of an essay in a fraction of a second, permitting real-time feedback within a web-based and/or cloud-based word processor type software known as an Interactive Editor.

In a non-limiting example, when analyzing one aspect of a particular essay type, the present innovation employs an algorithm to analyze and report to a writer and/or an instructor data correlated to a thesis statement, and a computed confidence that the thesis of an essay is stated well. Analyze the relationship between the component parts and the content required in an essay and the pre-determined context needed to make the components and content understandable to a reader. Detect and understand the key themes in context. Discover and provide an analysis for other constraints such as the strength of word selection and use, and associated grammatical constructs.

In an embodiment, the innovation reports the aforementioned metrics to an instructor who may monitor several students' writing progress from a central location. The central location may be a web or cloud connected monitoring station consisting of a user interface that provides specific information for the instructor on each student's progress, and permits the instructor to respond to student queries and/or provide feedback in real time through a network communication connection. The instructor may elect to provide additional feedback to each student or all students being monitored, based upon the instructor's determination of student needs. Separately, the innovation reports some version of the aforementioned metrics, or some prompt based upon the metrics directly to each student based upon his or her need as determined by the algorithm. In the event that the algorithm identifies a near-universally-present defect in writing, the algorithm may report a message of general information to the entire class of essay writers.

In an embodiment, an Essay Prompt, Key Themes, and a Sample Essay are input to the algorithm. Subsequently, upon receiving each word of a newly written essay, the receipt of which is ideally contemporaneous with its drafting, the algorithm computes the presence of action words and key words. The algorithm simultaneously computes the presence and types (for instance, introduction, body paragraph, or conclusion) of paragraphs, and the presence and types (for instance, Argumentative, Background, Declarative, Evidence, Question, or Thesis Statement) of sentences. The algorithm also computes the presence and types (for instance, Citation, Negative, Summary, or Text Reference) of strings. The algorithm performs similar or identical computations on the Sample Essay in light of the initially input Essay Prompts and Key Themes.

In an embodiment, the algorithm then computes a relationship between any pair of Key Words or Action Words. The algorithm similarly computes the presence and relationships among clusters of highly related Key Words. In a non-limiting example, an essay may be graded with respect to the Essay Prompts and Key Themes by computing thirty-six metrics through the various paragraph types. The algorithm then may return the average strength of the relationship between any Key Word and the Key Words in the Essay Prompt and Key Themes. It may return the number of Key Word clusters in the essay, or the number of spelling or grammar mistakes as a percentage of the total number of words in the essay.

As a non-limiting example, Helper Function “Compute Action Words” would be employed to split essay text into a list of words and punctuation, determine which words are verbs, and return a dataset of all words in the essay that are verbs. Helper Function “Compute Key Words” would be employed to split text into words and punctuation, determine the presence of modified nouns among the words and add such modified nouns to a second dataset. The same function may be used to identify database-present proper nouns connected to the essay text by stopwords, where a stopword is a common English word, often an article, such as “a,” “and,” “is,” “on,” of,” “or,” or “the.” The identifier “Key Word” contemplates both single words and identifiers containing multiple words. The function returns a dataset of all identified essay-present Key Words.

In an embodiment, he Mechanistic Assessment algorithm accepts as input an Essay Prompt, Key Themes, and a sample essay as free text, which can then be parsed using Helper Functions “Compute Action Words,” and “Compute Key Words.” The algorithm then computes from the Student Essay the existence and type of paragraphs, the existence and type of text, to which the algorithm applies Helper Functions “Compute Action Words” and “Compute Key Words.” The algorithm determines whether a paragraph includes one or more sentences, and prepares the sentences for further analysis.

In an embodiment, the algorithm applies one or more Tags to each one or more sentences. Tags may include designators such as, in non-limiting examples, “Argumentative,” “Background,” Declarative,” “Evidence,” “Question,” or “Thesis Statement.” The algorithm analyzes the full text for each identified sentence, and applies Helper Function “Compute Action Words,” and “Compute Key Words.” The algorithm determines whether a sentence includes one or more strings. Each identified string is allotted zero or more tags such as, in non-limiting examples, “Citation,” “Negative,” “Summary,” or “Text Reference.” The algorithm analyzes each string for constituent text, to which it applies Helper Functions “Compute Action Words,” and “Compute Key Words.”

In an embodiment, Tags identifying constituent paragraph parts are generated by the algorithm using Natural Language Processing techniques to determine if a constituent part, such as a sentence, belongs to a certain class.

In an embodiment, Helper Function “Compute Relationships” compares the relationship between any pair of Key Words or Action Words, referred herein as Terms. For instance, in a non-limiting example, the algorithm checks for an equality relationship between any two terms using approximate string matching. In a non-limiting example, these equality relationships may take the form of a “definition,” “synonym,” “example,” or “instance” relationship between any two Terms. The Helper Function “Compute Relationship” returns a relationship with the highest computed strength, or otherwise no relationship.

In an embodiment, Helper Function “Compute Key Word Clusters” creates a cluster per each Key Word, such cluster including the Key Word itself. The algorithm compares pairs of clusters to determine the strength of the relationship between any Key Words in any two clusters. In instances that the algorithm determines a strong relationship between any two Key Words, the algorithm merges the clusters including the Key Words. The function returns a set of clusters.

In an embodiment, the algorithm computes all metric values for the Introduction, Body paragraph, and Conclusion paragraphs, as well as any metrics, such as spelling and grammar, that apply to the essay as a whole. The algorithm may provide feedback to the instructor or writer by discretizing the possible metric values into various “buckets.” In a non-limiting example, the algorithm may present to the writer a combined computed result suggesting that the essay includes, “Too Little Detail,” “A Good Amount of Detail,” or “Too Much Detail.” If desired, the algorithm may be used to generate a number or letter grade based upon application of a grading function.

In an embodiment, the algorithm may include an authorship authentication routine that analyzes documents previously written by a student writer and determines the student's “fingerprint.” The fingerprint is derived from analysis and determination of features unique to, or uniquely absent from, the writer's known authored samples. Using the known fingerprint, the algorithm may then quickly and confidently be classified as authentic or inauthentic to the writer. The algorithm may then return a confidence indicator regarding the strength of the calculated classification.

Determination of the fingerprint of any given author is based on style of writing only and does not take into account the content of any given writing sample. Similarly, such determination ignores cited or quoted text, instead being based only upon text that the author claims to have written.

Such Determination and subsequent Authentication does not require a complete database of curated writing by other authors to ensure performance, nor does the combination suffer from being able to be manipulated by simple algorithms to cycle words or substitute synonyms, due to the complexity of the elements making up the fingerprint and the writer's own of the calculated fingerprint aspects. Consequently, writer attempts to game fingerprint determination tend merely to provide additional data to strengthen fingerprint determination, and thus raise the strength of the calculated classification.

In an embodiment, Determination and Authentication for an individual written work begins with assembling a collection of at least three documents with verified authentic authorship, referred to herein as the “Baseline.” The algorithm contains a database of other documents from other writers, referred to herein as the “World.” The algorithm is used to determine whether a newly presented document, referred to herein as “Document,” is likely to have been written by the purported author.

The algorithm may be used to compute a set of elements of writing, herein referred to as “Features,” that are unique to the Baseline, and hence unique to the verified author's writing generally. In a non-limiting example, Features of an author's writing may include the frequency of a particular type of punctuation, the frequency of a single oft-repeated word, or the frequency of a part of speech, such as a verb or plural noun. Features may alternatively include frequency of pairs of elements, such as punctuation followed by a part of speech, a single word followed by a part of speech, or a single word followed by a single word. Features are commonly determined based upon frequently occurring features such as simple, context-irrelevant words or known and context-irrelevant punctuation. As a consequence, regardless of the relevance of Baseline topics to Document topics, Feature analysis applies agnostically.

In an embodiment, the algorithm compares World Features to Baseline Features to determine those features of a verified author that distinguish his writing from all other World writers. To do so, the algorithm may compute a “Separation score” or “S-value.” The S-value is a number that is proportional to the uniqueness of any given individual Feature from the set of World Features. For instance, a low S-value for a particular Feature may represent that the product of verified authorship is, for that Feature at least, similar to the products of the World. Conversely, a high S-value for a particular Feature may represent a Feature that is highly idiosyncratic, and probably unique to that particular author. We use the S-values to identify the features that will best help us determine authenticity for future essays from this author.

The algorithm may then take as input the Document of unverified origin. The algorithm may compute a Classification Value for each Feature in the Document. In a non-limiting example, Feature Values would indicate whether a Feature falls within Baseline Values (value: 1), World Values (value: −1), or somewhere outside these two distributions (value somewhere between −1 and 1). The algorithm may then classify a Document by averaging the Classification Values. If the average of all Classification Values is positive, then the algorithm may classify the Document as authentic; if the average is negative than the algorithm may classify the Document as inauthentic; and, if the average is zero then the algorithm may classify the Document as unknown. The probability of the correctness of any classification may be measured by the magnitude of the average Classification Value.

In certain non-ideal instances, the authenticity of the Baseline may not be guaranteed, thus giving rise to the “Generalized Authentication Problem.” In such a scenario, the algorithm may be employed to analyze a collection of documents, herein referred to as “Documents2,” in light of a collection of other documents from other authors, referred to herein as “World2.” The algorithm may be employed to determine a “Baseline2” for the set of, “Documents2”

In a non-limiting example, assume that an instructor holds seven documents for which a student has claims authorship. Further pre-suppose that only five of these documents are works of genuine authorship by the student; two are works by another author. By employing the algorithm, the instructor cannot determine if any of the essays is authentic to the student, but the instructor can conclude that the author of two of the essays is not the author of five of the seven essays. Certainty regarding this conclusion may increase upon the algorithmic analysis of additional documents.

In an embodiment, all seven documents are sequentially iterated into two groups. A Baseline2 is calculated using six of the documents, and the algorithm classifies the seventh document. The algorithm may then be iterated to calculate a Baseline2 using five of the documents, then may classify the sixth and seventh document. The algorithm may then calculate a Baseline2 using four of the documents and classifying the fifth, sixth, and seventh documents. The algorithm would continue such iteration and calculation through the instance in which the Baseline2 dataset is one document, and the classified documents number the remainder.

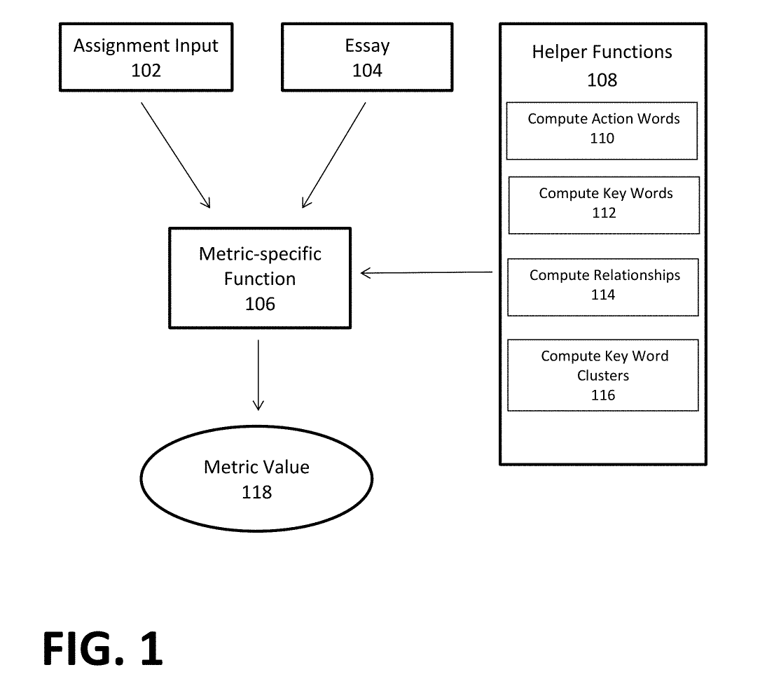

Turning now to FIG. 1, a process flow diagram for an exemplary system operation consistent with certain embodiments of the present invention is shown. In an embodiment, Assignment Input 102 may consist of indicia such as an Essay Prompt, Key Themes, and representative Essay, while a contemporaneously-drafted student Essay is shown at 104. Assignment Input 102 and Essay 104 are received as inputs to Metric-specific Function 106. Helper Functions 108 include Compute Action Words at 110, Compute Key Words at 112, Compute Relationships at 114, and Compute Key Word Clusters at 116. In application to Assignment Input 102 and Essay 104, Metric-specific Function 106 employs Helper Functions 108 to determine certain Metric Value 118 of the Essay 104. In an embodiment, Metric Value 118 is a ratio of the output of Helper Functions 108 as applied to Assignment Input 102 to the output of Helper Functions 108 as applied to Essay 104.

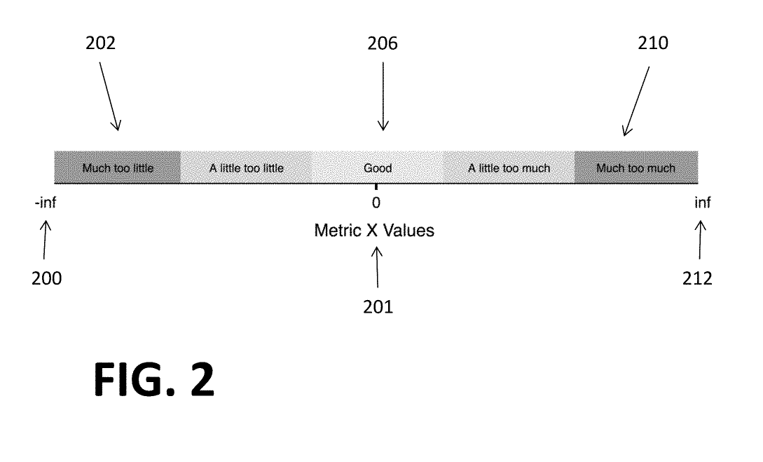

Turning now to FIG. 2, a spectrum of metric values diagram consistent with certain embodiments of the present invention is shown. Metric X Values 201 are shown in relationship to each other, from an unacceptably low extreme to an unacceptably high extreme. In an embodiment, at Much Too Little 202, calculated Metric Value is sufficiently low to suggest Essay author has employed too few of the specific inputs, such as descriptive detail, sufficient example, or illuminating analogy, in drafting the Essay. At Good 206, the calculated Metric Value suggests suitable application of specific inputs. At Much Too Much 210, the calculated Metric Value suggests over-application of specific inputs. −Inf 200 and Inf 212 represent unacceptable Metric Values on the very low side and the very high side, respectively.

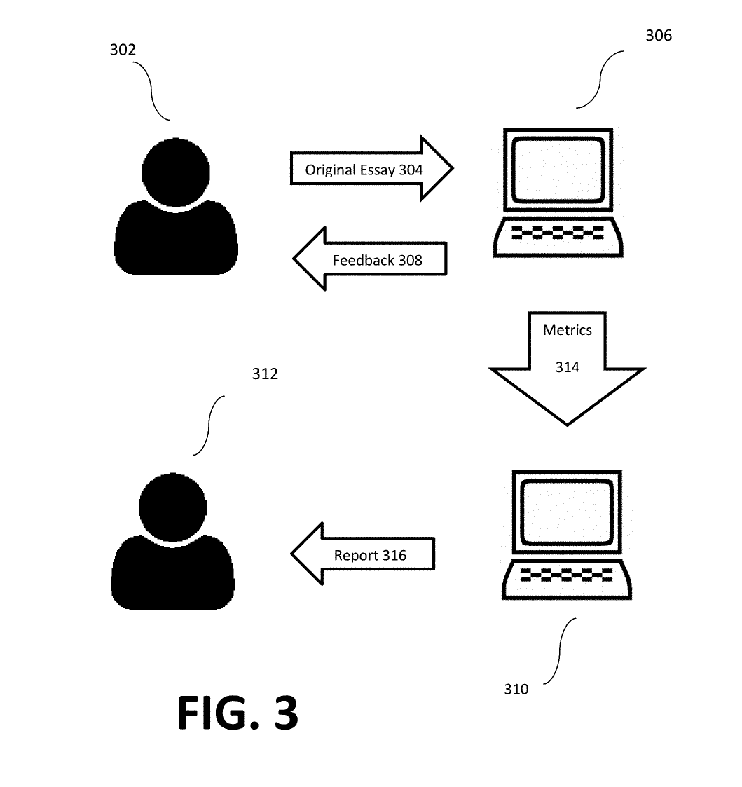

Turning now to FIG. 3, a system diagram consistent with certain embodiments of the present invention is shown. In an embodiment, Student 302 inputs Original Essay 304 at Node 306. Node 306 applies Metric-specific Function to Original Essay 304 in light of its application of Metric-specific Function to Assignment Input. Based upon calculated Metric Value's position on a spectrum, Node 306 returns drafting-contemporaneous Feedback 308 to Student 302. Simultaneously with the latter return, Node 306 may send calculated Metric Value or other related data to Node 310 for review by Instructor 312.

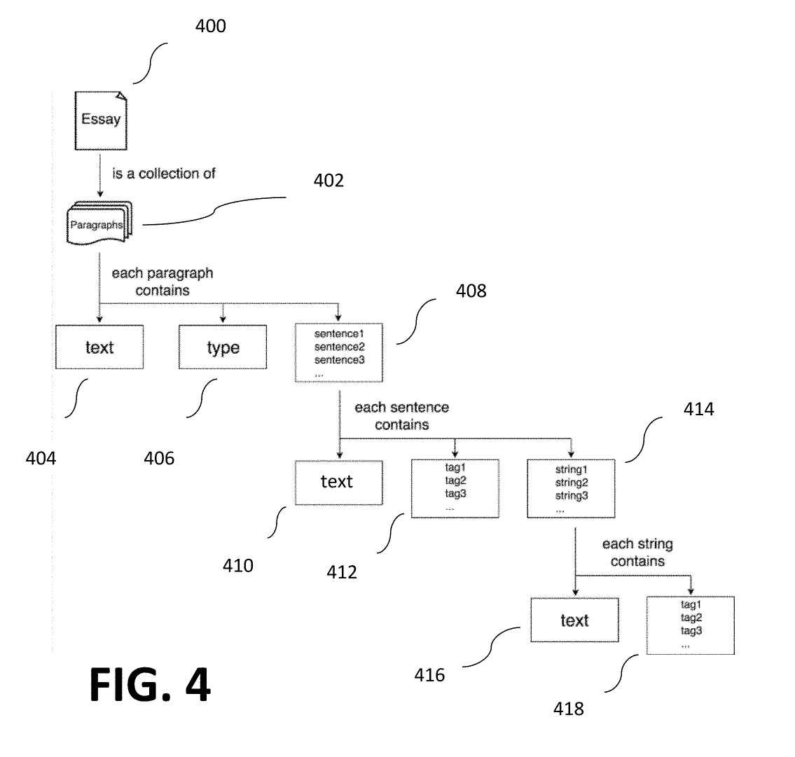

Turning now to FIG. 4, a process flow diagram of the determination of constituent parts of an essay consistent with certain aspects of the present invention is shown. Essay 400 can be understood as a collection of Paragraphs 402. Each paragraph of Paragraphs 402 can be understood to be characterized by Text 404, Type 406, and Sentences 408. In a non-limiting example, Type 406 may be Introduction, Body, or Conclusion. Each Sentence 408 can be understood to be characterized by Text 410, Tag 412, and String 414. In a non-limiting example, Tag 412 may represent sentence type such as Argumentative, Background, Declarative, Evidence, Question, and Thesis Statement. String 414 may be understood to be characterized by Text 416 and Tag 418. In a non-limiting example, Tag 418 may have zero or more constituent parts such as Citation, Negative, Summary, and Text Reference.

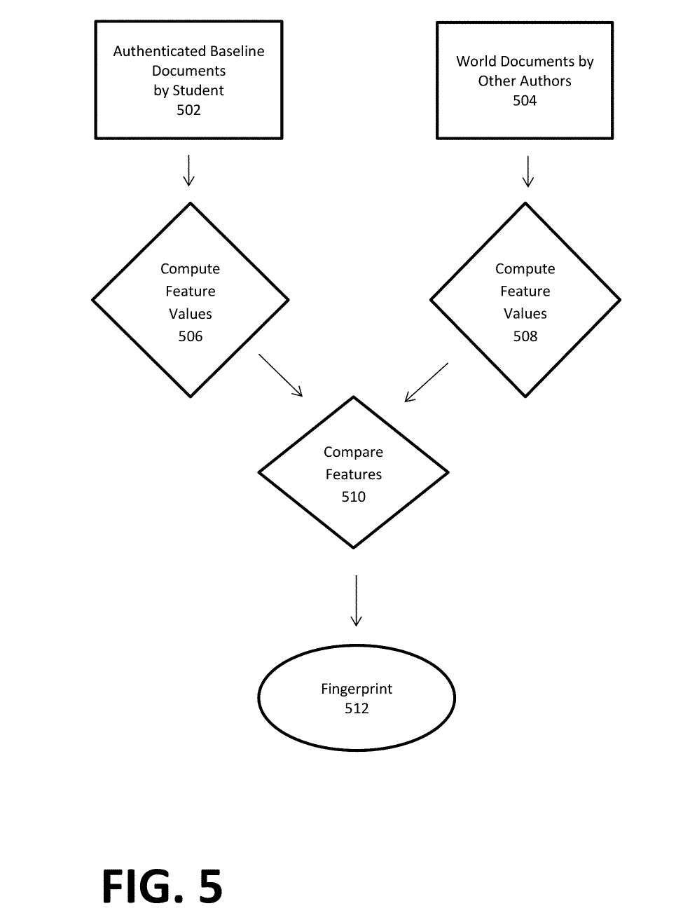

Turning now to FIG. 5, a process flow diagram of the determination of an author Fingerprint consistent with certain aspects of the present invention is shown. Authenticated Baseline Documents by Student 502 are input to the algorithm which computes the presence of Feature Values at 506. World Documents by Other Authors 504 are input to the algorithm which computes the presence of Feature Values at 508. Feature Values 506 and 508 are numerical values applied by the algorithm to each of the datasets based upon the presence and frequency of use within the dataset of generic Features called “stopwords,” often articles, that appear in all English writing. In a non-limiting example, the Feature Value for the stopword “the” may be 3%, and may represent 3% of the total document word usage. At 510 the Algorithm compares the Features based upon the Feature Values and outputs a Fingerprint 512.

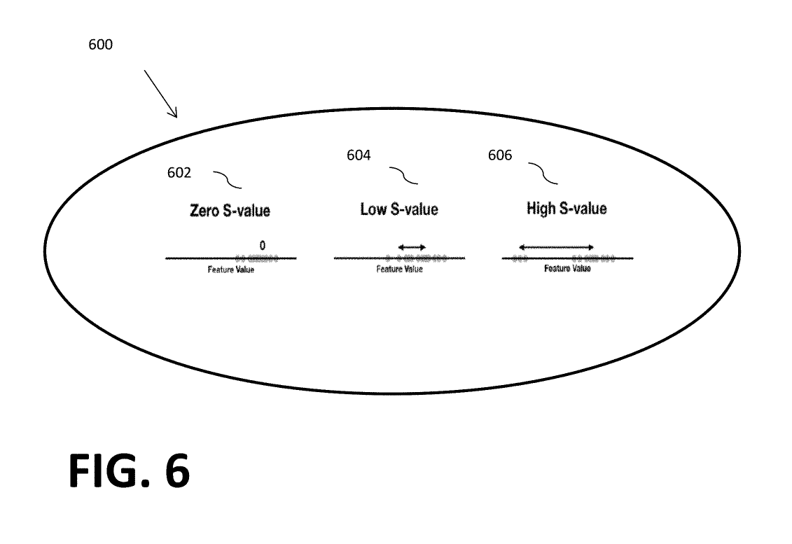

Turning now to FIG. 6, a detail diagram of the constituent determinations involved in calculating an author Fingerprint consistent with certain aspects of the present invention is shown. In an embodiment, author Fingerprint 600 can be expressed as a Separation Value or S-value, where a high S-value represents Baseline Values that are very different from World Values, and where a low S-value represents Baseline Values that are very similar to World Values. At 602, the S-value is zero, and does not reflect a stopword feature that distinguishes the author from other authors. At 604, the S-value is low, and the Baseline and World Values are weakly separated. At 606 the S-value is high, and the Baseline and World Values are highly separated.

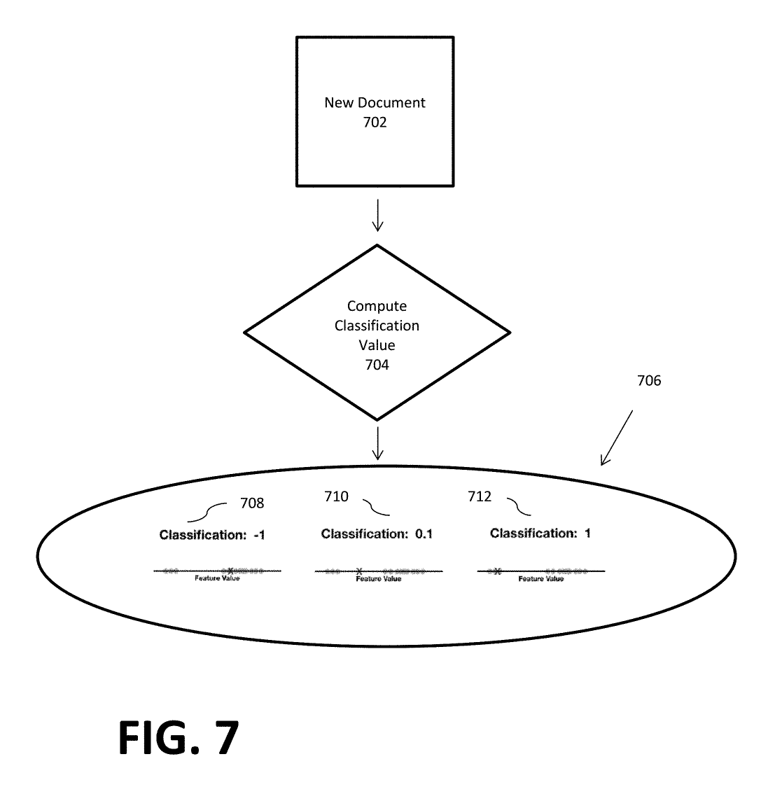

Turning now to FIG. 7, a process flow diagram of the determination of Classification Values for a new document of undermined authorship consistent with certain aspects of the present invention is shown. Algorithm accepts New Document 702 of unverified authorship and at 704 computes a Classification Value. Classification Value 706 can be expressed as 1 if a Feature Value falls within Baseline Values (At 712); as −1 if a Feature Value falls within World Values (At 708); or as between 1 and −1 if it falls between these two distributions (At 710).

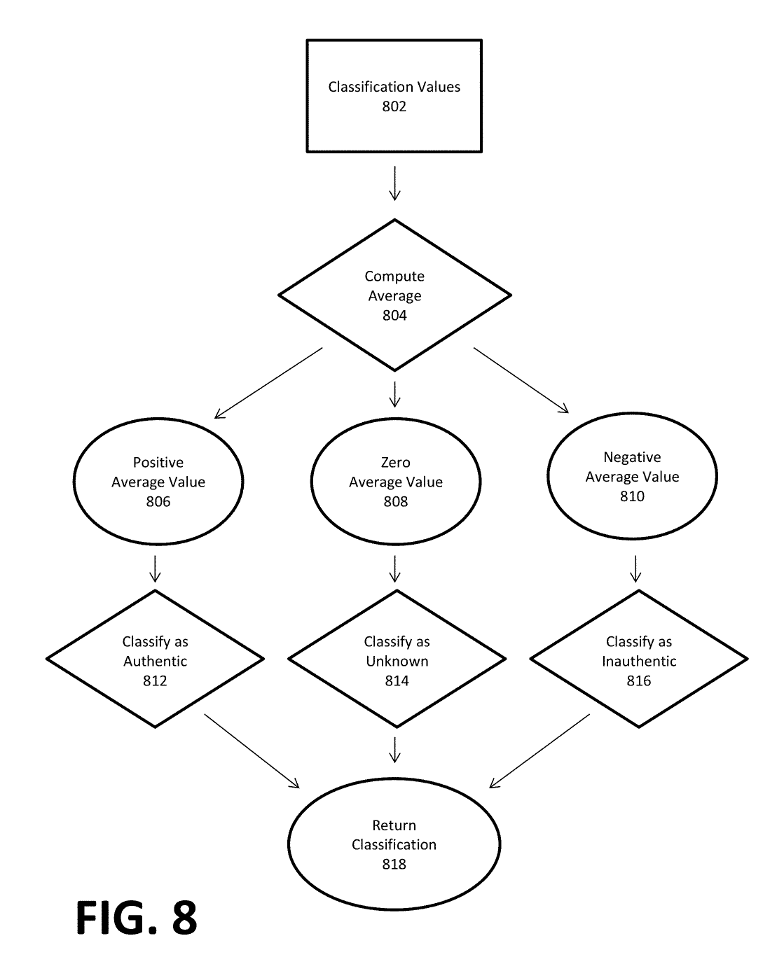

Turning now to FIG. 8, a process flow diagram of the application of Classification Values to determination of an essay classification consistent with certain aspects of the present invention is shown. In order to classify an individual essay, the algorithm takes as input Classification Values 802. Computing the Average of input values at 804, the algorithm outputs one of: a Positive Average Value at 806, a Zero Average Value at 808, or a Negative Average Value at 810. If the output is positive, the algorithm classifies the essay as authentic at 812. If the output is negative, the algorithm classifies the essay as inauthentic at 816. If the output is zero, the essay is classified as unknown. The algorithm returns the Classification at 814.

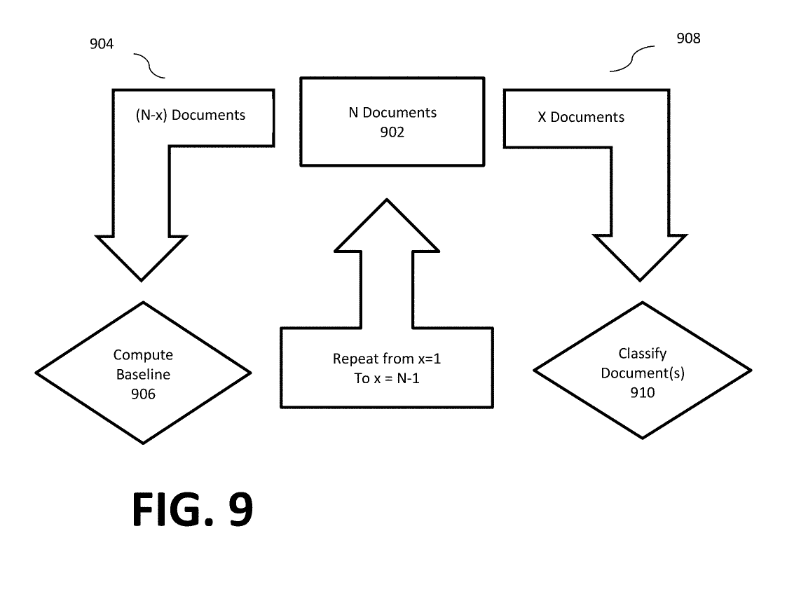

Turning now to FIG. 9, a process flow diagram of analysis of a set of documents of unknown authorship in the absence of a baseline of documents with verified authorship, consistent with certain aspects of the present invention is shown. In the absence of a pool of documents with verified authorship, the algorithm may be used to determine if a collection of at least three documents is likely the product of only one or more than one author. At 902, the pool of documents of unknown authorship is composed of N items, where N is greater than or equal to 3. At 904 the algorithm accepts as input (N−x) Documents, where x=1. At 906 the algorithm computes a Baseline. At 908 the algorithm accepts as input the outlying document represented by x. The algorithm classifies Document x at 910. The algorithm then iterates the document pool of N items from x=1 to x=N−1 until all iterative subsets of documents have been used to compute a baseline at 906 and receive classification at 910.

While certain illustrative embodiments have been described, it is evident that many alternatives, modifications, permutations and variations will become apparent to those skilled in the art in light of the foregoing description.

We claim:

1. A method of essay evaluation, comprising:
establishing communication between a server and one or more devices;
the server receiving one or more human-language-drafted essays from the one or more devices;
computing the presence and relationship of certain pre-defined metrics in the one or more human-language-drafted essays during the action of drafting said human-language-drafted essays;
comparing the computed presence and relationship of certain pre-defined metrics to one or more pre-determined values;
delivering a first automated assessment based upon such comparison; and
delivering a second automated assessment and corrective instructions, the content of which is at least partially based upon deviance of metrics from pre-determined values.

2. The method of claim 1, the human-language-drafted essays being in written form of any human language.

3. The method of claim 1, the human-language-drafted essays being of any type including at least a paragraph of text on a subject in the Humanities and/or Social Sciences.

4. The method of claim 1, the pre-defined metrics being sought regardless of essay type.

5. The method of claim 1, further comprising said first automated assessment being delivered to an instructor or other human monitor.

6. The method of claim 1, further comprising said second automated assessment and corrective instructions being delivered to at least the author of the essay.

7. The method of claim 1, the first automated assessment and the second automated assessment and corrective instructions delivered contemporaneously with the drafting of the essay.

8. A system of essay evaluation, comprising:
a first user interface;
one or more second user interfaces;
a server having a processor in communication with said one or more second user interfaces;
the server receiving one or more human-language-drafted essays from the one or more devices;
computing the presence and relationship of certain pre-defined metrics in the one or more human-language-drafted essays during the action of drafting said human-language-drafted essays;
comparing the computed presence and relationship of certain pre-defined metrics to one or more pre-determined values;
delivering to said first user interface a first automated assessment based upon such comparison; and
delivering to said one or more second user interfaces a second automated assessment and corrective instructions, the content of which being based upon deviance of metrics from pre-determined values.

9. The system of claim 8, the human-language-drafted essays being in written form of any human language.

10. The system of claim 8, the human-language-drafted essays being of any type including at least a paragraph of text on a subject in the Humanities and/or Social Sciences.

11. The system of claim 8, the pre-defined metrics being sought regardless of essay type.

12. The system of claim 8, the first automated assessment being delivered to an instructor or other human monitor.

13. The system of claim 8, the second automated assessment and corrective instructions being delivered to at least the author of the essay.

14. The system of claim 8, the first automated assessment and the second automated assessment and corrective instructions delivered contemporaneously with the drafting of the essay.
